(19) United States
(12) Patent Application Publication
(10) Pub. No.: US 2015/0265893 A1
(43) Pub. Date: Sep. 24, 2015

(54) System and Methods for Baseball Bat Construction

(71) Applicant: Louis A. Ledoux, JR., Fall River, MA (US)

(72) Inventor: Louis A. Ledoux, JR., Fall River, MA (US)

(21) Appl. No.: 14/635,423

(22) Filed: Mar. 2, 2015

Related U.S. Application Data
(60) Provisional application No. 61/946,752, filed on Mar. 1, 2014.

(51) Int. Cl. A63B 59/06; B27D 1/08; A63B 59/00

(52) U.S. Cl. CPC A63B 59/06; A63B 59/0074; B27D 1/086

(57) ABSTRACT

The present invention has to do with a method and system for producing defect free wood bats suitable for major league play.

### CROSS-REFERENCE TO RELATED APPLICATIONS

The present application is related to, claims the earliest available effective tiling date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:
1. U.S. provisional patent application 61/946,752, entitled “Systems and Methods for Baseball Bat Construction”, naming Louis A. Ledoux as inventor, filed 1 Mar. 2014.

### BACKGROUND

1. Field of Use

This invention relates to an improved method for constructing baseball bats. More specifically, the invention relates to methods for constructing wooden baseball bats and handles free of internal defects.

2. Description of Prior Art (Background)

Baseball bats, particularly those constructed of wood, are well known in the art. Baseball bats approved for use in the professional major leagues are turned from a solid piece of wood and include a handle portion terminating at a first or lower end in an integral. knob. An outwardly tapered intermediate portion extends from the handle portion and merges upwardly with a ball hitting barrel portion, said barrel portion terminating at a second or upper end.

The most widely used wooden bats are fabricated of a hardwood such as maple or where ash is derived from ash trees having the scientific classification: family: Oleaceae; genus: Fraximus. Ash wood is hard, strong and stiff, and possesses a relatively straight grain. Hardwoods in general have a cellular structure which includes vessels of a continuous elongated nature. When said vessels are cut transversely across the gain direction, the exposed open end is caused to have open pores. Because such pores extend the length of a piece of the wood in the direction of the grain, said hard woods are considered to be porous woods.

Such hardwood bats, however, are very prone to chipping, denting and outright breaking during game play. It is thought that, under typical strenuous conditions, the bat will momentarily assume a shape that is very slightly sinusoidal. Typically, there will be two momentary nodes along the length of the bat, between which the bat will be deformed for a short period to a greater or lesser degree. Many factors may determine the amplitude and frequency of the vibration, including the structure of the bat, the grip strength and location by the player, the point of impact of the ball and the speed and direction of the ball and bat. If the impact of the ball is sufficiently forceful, and several of the above factors combine unfavorably, the bat will break.

Some prior art solutions suggest using the harder and more resilient woods over the softer and less resilient woods such as, for example, red oak over ash. However, prior efforts to fabricate approved baseball bats of red oak have generally been unsuccessful because of difficulties in drying thick billets of red oak without warping and/or cracking. Solutions to that problem included impregnated with various agents in fluid form to achieve property modifications. However, such impregnation treatments have not been successfully applied to baseball bats. It is further known that various coatings and wrappings have been applied to the handle portion of baseball bats in an effort to minimize breakage or mitigate the effects thereof. Such expedients have either been unsuccessful, disapproved for Major League use, or have adversely affected desirable characteristics of the bat. Other prior art solutions include laminations of various types, however, again, these are generally not allowed for Major League play.

In any case, when a bat breaks in major league play or practice there is a strong possibility of serious injury if one or more of the broken bat pieces strikes a person. Indeed, Major League Baseball Bat Supplier regulations require all suppliers to carry, at their own expense, general liability insurance throughout the baseball season.

It will be appreciated that due to a combination of the forces involved and the strength characteristics of most bats, the location of the break is almost invariably at a location between the aforementioned nodes, in the handle, or in the area of transition between the handle and the barrel.

It will also be appreciated that a break is more likely if an area of the wooden bat is defective such as a void, rot, or other defect. During construction, wooden bats undergo constant visual inspection. For example, a visual inspection would include: visual surface checking or end splits; no surface evidence of decay, such as brown rot or black-line spalting; a slope of grain no greater than 1 in 20 inches (3 degrees) on both the radial (edge) and tangential (face) grain surfaces; no knots, knot clusters, worm holes or bark inclusions; no excessive localized grain deviations due to a nearby knot that was processed out of the billet; and no excessive curly- or wavy-min that could act as a strength-reducing characteristic.

However the present methods fail to uncover bidden or otherwise not visible defects. It is accordingly an object of the present invention to provide a safer wooden baseball bat free of visible and hidden defects.

Even though wooden bats frequently break in use, thus creating the possibility of injury, the safety measures and alternative materials for bat construction proposed by the prior art have in large part been rejected. No approach taken in the prior art prevents the separation of the broken piece of a bat from the handle portion without also adversely affecting the weight, balance, feel, flexibility and sound of the traditional wooden bat. Hence, ball players can readily appreciate the advantages offered by a bat construction which preserves the characteristics of the traditional bat while preventing a broken piece from completely separating from the handle portion.

### BRIEF SUMMARY

The foregoing and other problems are overcome, and other advantages are realized, in accordance with the presently preferred embodiments of these teachings.

In accordance with one embodiment of the present invention a method for producing defect free wood bats is disclosed. The method includes non-destructive testing (NDT) a wood billet, wherein NDT further includes: visually inspecting the wood billet for surface defects; and scanning the wood billet for non-visual internal defects. Scanning the wood billet for non-visual defects is selected from the scanning group of spectroscopy, sound velocity testing, eigen frequency testing, x-ray testing, synchrotron testing, and electrical resistance testing, depending on the wood species and type of defect prevalent for that type species. The method includes analyzing the wood billet NDT results and then processing the wood billet. Processing the wood billet includes weighing the wood billet and determining a true axis of the wood billet. The true axis of the wood billet is determined and the wood billet is installed and centered on a lathe to trim the wood billet to form an intermediate bat form The intermediate bat form comprises an axis centered barrel alignment block section; an axis centered bat section shape; and an axis centered handle alignment block section. The trimmed wood billet is inspected for visual defects and verifying or determining that the bat section slope of grain is less than 3 degrees. The method includes removing the alignment blocks from the trimmed wood billet to form a nearly finished bat, cupping the bat to a desired bat weight; and visually inspecting the bat for surface defects. The bat is scanned for non-visual defects, wherein scanning the bat for non-visual defects is selected from the scanning group of spectroscopy, sound velocity testing, eigen-frequency testing, x-ray testing, synchrotron testing, and electrical resistance testing, and analyzing scan test results. The type of scan selected is dependent upon the wood species and typical defects associated with the wood species.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A is a perspective view of a wooden billet before being shaped into a bat blank;

FIG. 1B is a perspective view of a bat blank before being shaped into a bat;

FIG. 1C is a perspective view of a bat blank before being shaped into a bat;

FIG. 2 is a plan view of a wood baseball bat showing constituent parts; (cup, head/barrel, taper, handle, knob, sweet spot/area, grip area);

FIG. 3 is a plan view of a wood baseball bat showing bat and forces at impact; (kinetic energy, bat & ball forces);

FIG. 4 is a plan view of a bat under which are aligned graphic representations of the first, second, and the third bending modes of the wood bat, indicating the relative vibrational proclivities of each mode;

FIG. 5 is a plan view of a wood bat showing off-node bending impact of ball/bat collision; and

FIG. 6 is a method flow chart of one embodiment of the present invention.

### DETAILED DESCRIPTION

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

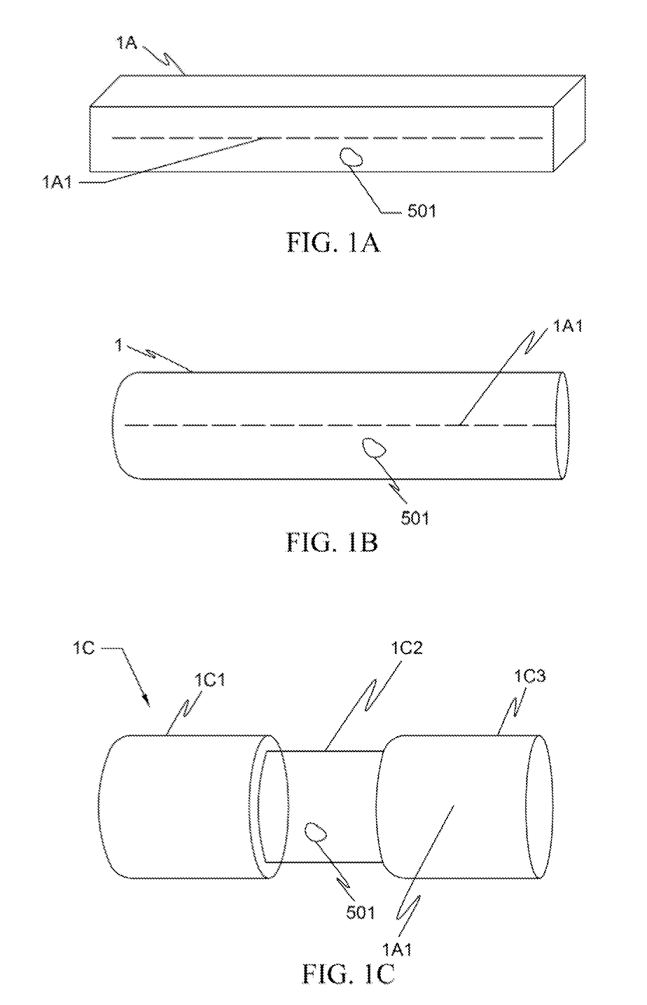

FIG. 1A is a perspective view of a wooden billet 1A. FIG. 1B is a perspective view of a bat blank 1 formed from wooden billet 1A, having a non-visual defect 501, before being shaped into a bat. It is a single, solid piece of non-laminated and non-composite wood which is ready to be lathe-turned into a wooden baseball bat. The blank 1 is shown after the rectangular wood billet 1A has been turned in a lathe until it is round in shape, and is a certain diameter along its length. Continued turning in a lathe enables the shaping of the blank 1 into a bat.

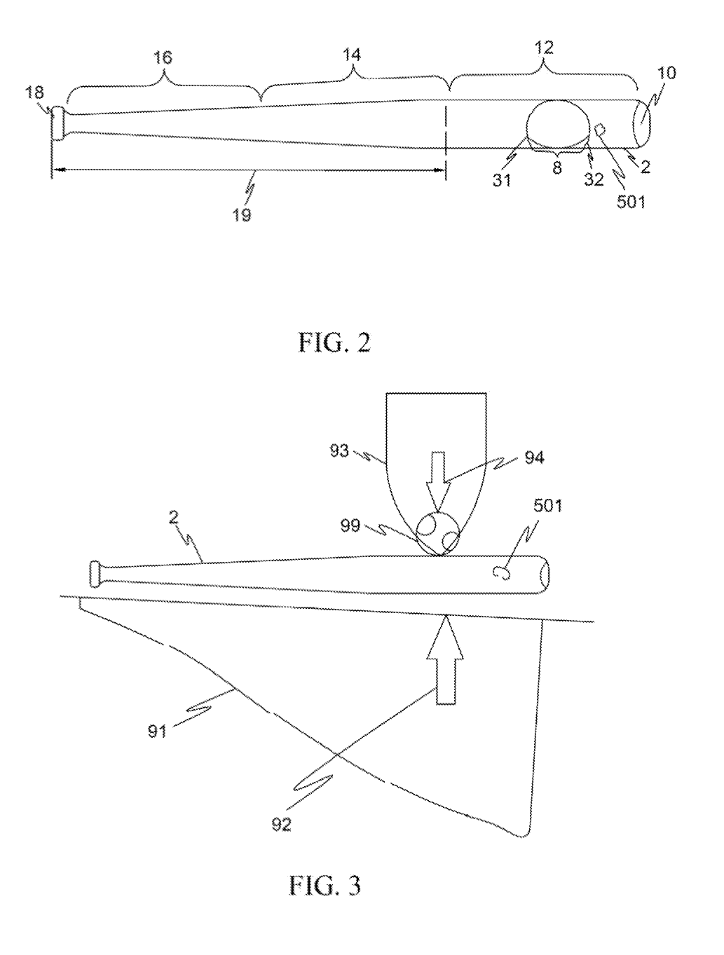

FIG. 2 is a plan view of a wooden baseball bat 2 developed from defective wooden bat blank 1 shown in FIG. 1, showing areas and names: cup 10, barrel 12, taper 14, handle 16, showing their approximate boundaries, and knob 18. Also shown is the sweet spot area 8, defined by the nodes of the first 31 and the second 32 bending modes of the bat wood. The grip area 19 is the 18 inch-long length of the handle of the bat where Major League Baseball (MLB) rules allow the application of a grip enhancer, such as pine tar.

FIG. 3 is a plan view of the wood baseball bat 2 showing kinetic forces at bat nail 99 impact, including a graphic representation of bar momentum 91 along the length of the bat, and a graphic of the hall's momentum 93. Also shown is the locus of force of the bat 92, and the locus of force of the ball 94.

FIG. 4 is a plan view of the bat 2 under which plan view are aligned graphic representations of the first 51, second 52, and the third 53 bending modes of the wood bat, indicating the relative vibrational characteristics of each mode. The nodes 31 and 32 are considered to define the general sweet spot area 8 where ball impact would absorb the least of the ball's 99 (FIG. 3) momentum and excite the least vibrations in the bat 2. The internodes 41, 42, and 43 indicate the area along the length of the bat where the bat will be maximally excited by ball impact. Also are indicated areas along the bat 2, of potential ball impact, where the probability of breakage is the greatest, indicated by “Danger zone,” 57, “Critical” 58 and “High Probability of Breakage” 59. Legend 55 shows that nodes are depicted with a dot (•) and internodes are depicted with an X.

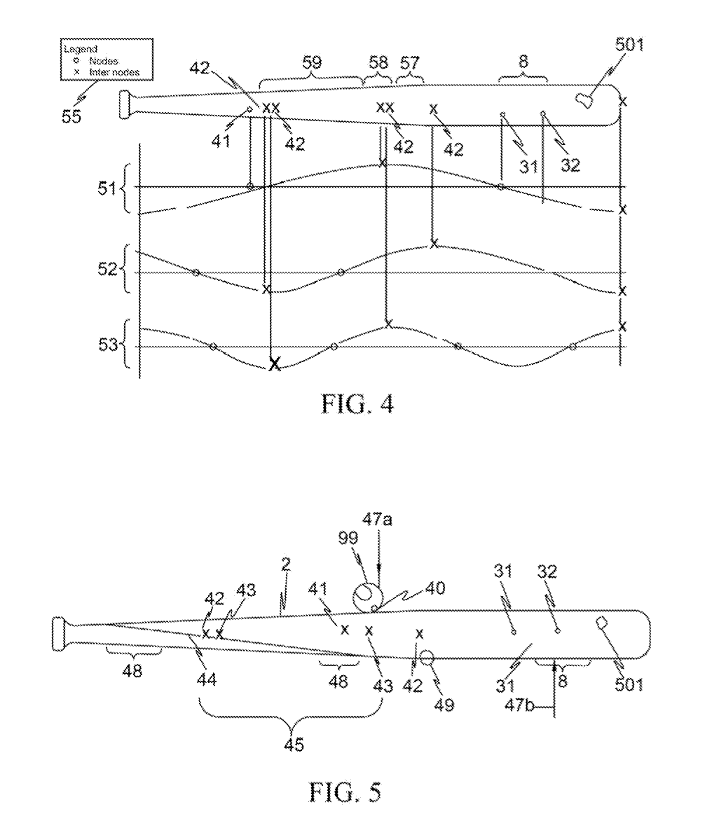

FIG. 5 is a plan view of a wood. bat 2 showing off-node bending impact of ball/bat collision. Ball 99 impact point 40 and center of relative ball momentum 47a are shown. Center of relative bat momentum 47b is shown. The first 41, second 42 and third 43 internodes of the bending modes are shown, which if struck in this area, will result in the most absorption of the ball's momentum and the greatest bending moment, greatest resultant bat vibration and greatest potential for breakage. The grain line 44 of a 1:20 slope of grain (SOG) is shown. The location of maximum shear and tension stress 49 are shown on the bat's grain 44. The bracket 45 depicts the general area along the length of a wood bat where a ball impact would have the greatest probability of breaking the bat.

It will be appreciated that non-visual defect 501 shown in FIGS. 1-5 can be any sort of non-visual defect, such as a void, tree rot, fungal infections, damage due to natural causes, or animal or insect damage, or defects due to the manufacturing process, e.g., lathe turning.

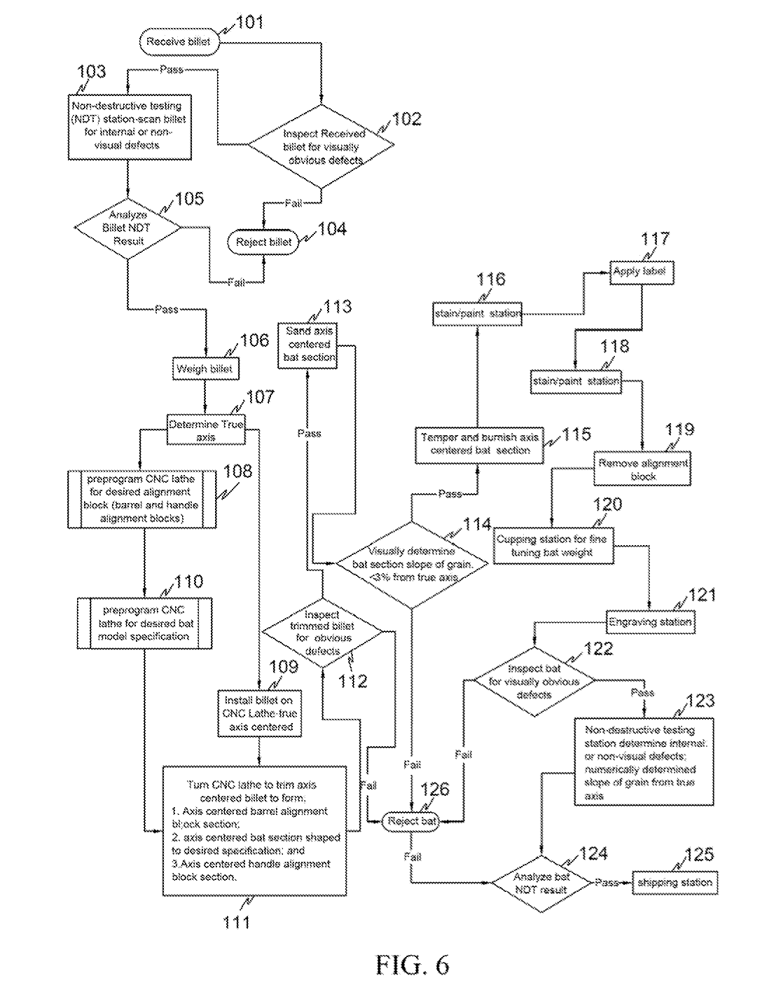

Referring also to FIG. 6, there is shown a method flow chart of one embodiment of the present invention for producing a defect free baseball bat or wooden handle.

The wood billet 1A is received 101. The wood billet 1A may be any suitable species, such as, for example, True Hickory (Carya ovata, laciniosa, glabra); White Ash (Fraxinus americana); Sugar (Hard) Maple (Acer saccharum); Yellow Birch (Betula alleghaniensis); Red Oak (Quercus rubra); Tamo (Japanese Ash) (Fraxinus mandschurica); Aodamo (Japanese Ash) (Fraxinus lamiginose); and European Beech (Fagus sylvatica).

The wood billet 1A is inspected for any visually obvious defects 102. If visual defects are discovered the billet 1A is rejected 104.

Next, the billet is subjected to non-destructive-testing (NDT) 103 for internal or otherwise non-visual defects. NDT may include, for example, and not limited to: spectroscopy; sound velocity testing; eigen frequency; x-ray; optical systems; neutrons; synchrotron (x-ray with high resolution); static deformation (stress grading); microwaves; and or electrical resistance. The type of NDT may be correlated to the wood billet species and or the type of defects normally associated with the species.

The results of the NDT test are analyzed at step 105. It will be appreciated that the analysis will largely depend on the type of NDT. For example, the electrical properties such as electrical resistance, dielectric properties, and/or piezoelectric properties may be used to determine equilibrium moisture content (EMC), knots, and/or fiber angle. Sound velocity or wave propagation NDT (e.g. ultra sound) may be used to determine if cracks or voids are present in the billet. Wave propagation may also be used to determine the billet's modulus of elasticity (MOE). Other NDT includes thermography used for detecting knots or coating defects (discussed herein); and x-ray or radar for detecting cracks or voids and/or density profiles.

It will appreciated that while NDT is shown at step 103, NDT may be distributed throughout the bat manufacturing process. For example, x-ray NDT may be used at step 103 while ultra-sound NDT may be used at step 123. It will be further appreciated that the manufacture of a bat is a labor intensive process and each step invests some amount of time and money into a bat that may be ultimately rejected. Thus, NDT and/or different types of NDT may be done often throughout the process.

Still referring to FIG. 6, with acceptable NDT results from step 105, the billet is weighed 106 and it's true, or actual central axis (FIG. 1A-1A1) is determined 107.

A computer numerically controlled (CNC) lathe is preprogrammed for appropriate barrel and handle alignment blocks along with a desired bat model, 108, 110, respectively. The billet is installed on the CNC lathe with its true axis (FIG. 1A-1A1) aligned coaxially with the lathe's turning axis 109.

The CNC lathe forms from the bat blank (FIG. 1B-1) a continuous wood structure (FIG. 1C-1C) comprising: an axis centered barrel alignment block section (FIG. 1C-1C1); an axis centered bat section (FIG. 1C-1C2) substantially shaped to desired specifications; and an axis centered handle alignment block section 111 (FIG. 1C-1C3).

The trimmed billet is inspected for any obvious defects 112 before sanding station 113. After sanding, the bat section is inspected for a slope of grain less than 3 degrees. Failing either step 112, or 114 and the billet is rejected 126.

Next the bat section is tempered and burnished 115 before arriving at the first stain/paint station 116. Next a label may be applied to the bat section 117 before the second stain/paint section 118.

The alignment blocks (FIG. 1C-1C1, 1C3) are then removed 119 and the bat section barrel end is cupped a suitable amount to fine tune the weight of the bat to the desired specification. The bat is then engraved 121 and again visually inspected for defects 122.

The finished bat is tested (NDT) 123 for internal or otherwise non-visual defects prior to shipping 125. It will be understood that the NDT may be any suitable NDT such as described earlier and repeated here. NDT may include, for example, and not limited to: spectroscopy; sound velocity testing; eigen frequency; x-ray; optical systems; neutrons; synchrotron (x-ray with high resolution); static deformation (stress grading); microwaves; and or electrical resistance.

Likewise, the results of the NDT test are analyzed at step 124. As before, it will be appreciated that the analysis will largely depend on the type of NDT. For example, the electrical properties such as electrical resistance, dielectric properties, and/or piezoelectric properties may be used to determine equilibrium moisture content (EMC), knots, and/or fiber angle. Sound velocity or wave propagation NDT (e.g., ultra sound) may be used to determine if cracks or voids are present in the billet. Wave propagation may also be used to determine the billet's modulus of elasticity (MOE). Other NDT may include thermography used for detecting knots or coating defects; and x-ray or radar for detecting cracks or voids and/or density profiles.

Failure of the NDT results in the bat being rejected 126.

Favorable NDT results and the defect free bat is bagged to protect it from moisture and shipped to the ordering customer 125.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the appended claims.

What is claimed is:

1. A method for constructing defect free baseball bats, the method comprising:
receiving a wood billet;
non-destructive testing (NDT) the wood billet; and
processing the wood billet.

2. The method as in claim 1 wherein NDT further comprises:
visually inspecting the wood billet for surface defects; and
scanning the wood billet for non-visual defects.

3. The method as in claim 2 wherein scanning the wood billet for non-visual defects is selected from the scanning group of spectroscopy, sound velocity testing, eigen frequency testing, x-ray testing, synchrotron testing, and electrical resistance testing.

4. The method as in claim 3 further comprising analyzing the wood billet NDT results.

5. The method as in claim 4 further comprising weighing the wood billet.

6. The method as in claim 5 further comprising:
determining a true axis of the wood billet;
installing and true axis centering the wood billet on a lathe and turning lathe to trim the wood billet to form;
an axis centered barrel alignment block section;
an axis centered bat section shape; and
an axis centered handle alignment block section.

7. The method as in claim 6 further comprising inspecting the trimmed wood billet for visual defects.

8. The method as in claim 7 further comprising visually determining bat section slope of grain is less than 3 degrees.

9. The method as in claim 8 further comprising:
removing alignment blocks from the trimmed wood billet to form a bat; and
cupping the bat to a desired bat weight.

10. The method as in claim 9 further comprising:
visually inspecting the bat for surface defects;
scanning the bat for non-visual defects, wherein scanning the bat for non-visual defects is selected from the scanning group of spectroscopy, sound velocity testing, eigen-frequency testing, x-ray testing, synchrotron testing, and electrical resistance testing; and
analyzing scan test results.

11. A method for constructing defect free baseball bats, the method comprising:
receiving a wood billet;
determining the species of the wood billet;
non-destructive testing (NDT) the wood billet, wherein NDT further comprises:
visually inspecting the wood billet for surface defects;
correlating the wood species with a suitable scanning technique and scanning the wood billet for non-visual defects, wherein scanning the wood billet for non-visual detects is selected from the scanning group of spectroscopy, sound velocity testing, eigen frequency testing, x-ray testing, synchrotron testing, and electrical resistance testing;
analyzing the wood billet NDT results;
processing the wood billet, wherein processing the wood billet comprises:
weighing the wood billet;
determining a true axis of the wood billet;
installing and true axis centering the wood billet on a lathe and taming lathe to trim the wood billet to form an intermediate bat form comprising;
an axis centered barrel alignment block section;
an axis centered bat section shape;
an axis centered handle alignment block section;
inspecting the trimmed wood billet for visual defects;
visually determining bat section slope of grain is less than 3 degrees;
removing alignment blocks from the trimmed wood billet to form a bat;
cupping the bat to a desired bat weight;
visually inspecting the bat for surface defects;
scanning the bat for non-visual defects, wherein scanning the bat for non-visual defects is selected from the scanning group of spectroscopy, sound velocity testing, eigen-frequency testing, x-ray testing, synchrotron testing, and electrical resistance testing; and
analyzing scan test results.
